(19) United States
(12) Patent Application Publication
(10) Pub. No.: US 2019/0143492 A1
(43) Pub. Date: May 16, 2019

(54) DUAL SIDED DRILL BIT SYSTEM

(71) Applicant: Nuo Ljucovic, Pt Jefferson Station, NY (US)

(72) Inventor: Nuo Ljucovic, Pt Jefferson Station, NY (US)

(21) Appl. No.: 15/813,357

(22) Filed: Nov. 15, 2017

(51) Int. Cl. B25B 23/00; B23B 51/02; B25B 21/00; B23B 45/00; B23B 31/10

(52) U.S. Cl. CPC B25B 23/0035; B23B 51/02; B23B 31/101; B23B 45/003; B25B 21/007

(57) ABSTRACT

A dual sided drill bit system to facilitate the switch between a drilling tool and a screw driver tool includes a power drill that has a chuck. A receiver is removably coupled to the chuck. The receiver has an open end that extends into a cavity of the receiver. A bit is included that has a first section, a second section and a middle section positioned between the first and second sections. The first, second and middle sections form a unitary structure. The first section has a first end positioned opposite of the middle section and the second section has a second end positioned opposite of the middle section. The first section comprises a drill bit and the second section comprising a screw driver. The bit is removably extended into the receiver such that a selected one of the first or second sections extends outwardly away from the receiver.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to power tool devices and more particularly pertains to a new power tool device for facilitating the switch between a drilling tool and a screw driver tool.

### (h) BRIEF SUMMARY OF THE INVENTION

An embodiment of the disclosure meets the needs presented above by generally comprising a power drill that has a chuck. A receiver is removably coupled to the chuck. The receiver has an open end that extends into a cavity of the receiver. A bit is included that has a first section, a second section and a middle section that is positioned between the first and second sections. The first, second and middle sections form a unitary structure. The first section has a first end positioned opposite of the middle section and the second section has a second end positioned opposite of the middle section. The first section comprises a drill bit and the second section comprising a screw driver. The bit is removably extended into the receiver such that a selected one of the first or second sections extends outwardly away from the receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of components of a dual sided drill bit system according to an embodiment of the disclosure.

FIG. 2 is a front view of an embodiment of the disclosure.

FIG. 3 is a top view of an embodiment of the disclosure.

FIG. 4 is a side view of an embodiment of the disclosure.

FIG. 5 is a perspective view of components of an embodiment of the disclosure.

FIG. 6 is a cross-sectional view of an embodiment of the disclosure taken along line 6-6 of FIG. 4.

### (j) DETAILED DESCRIPTION OF THE INVENTION

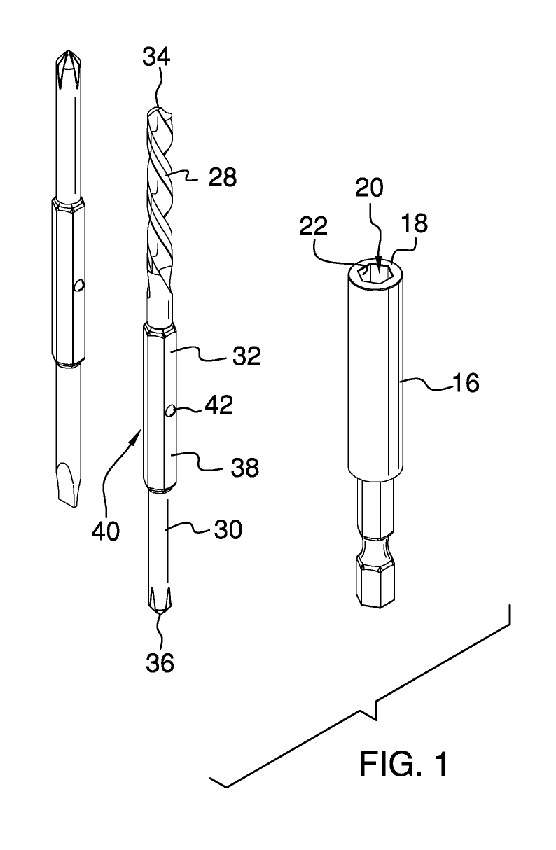

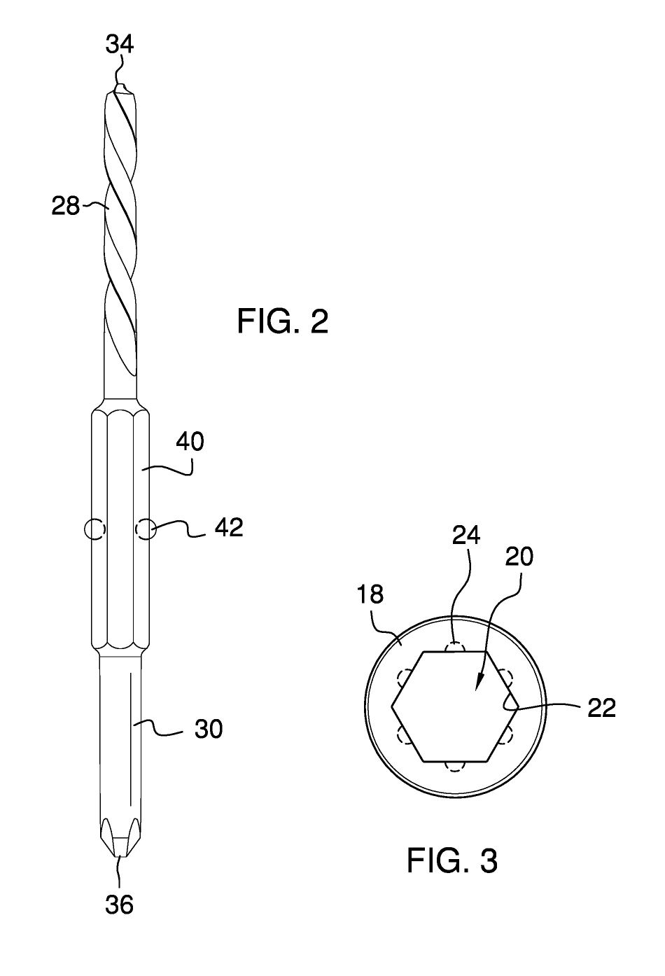

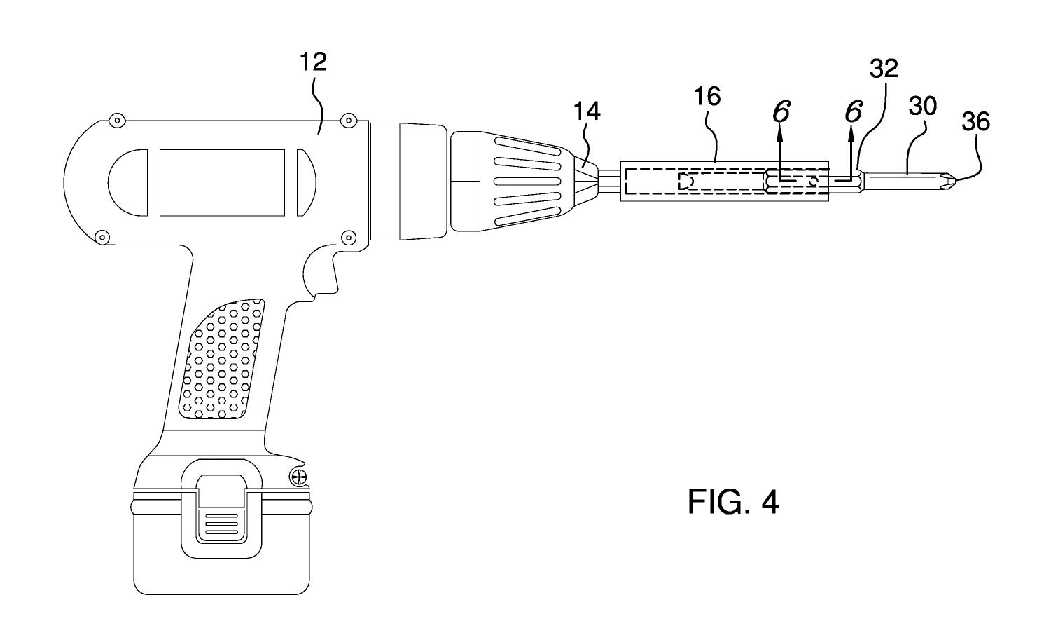

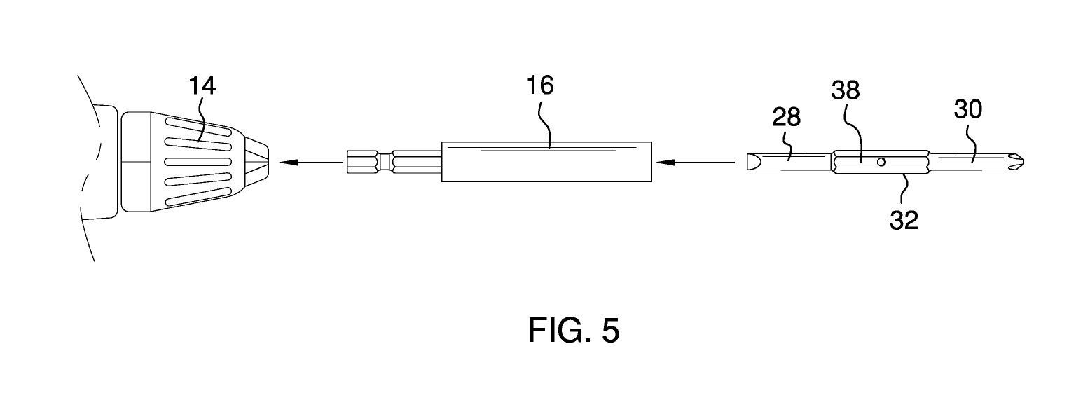

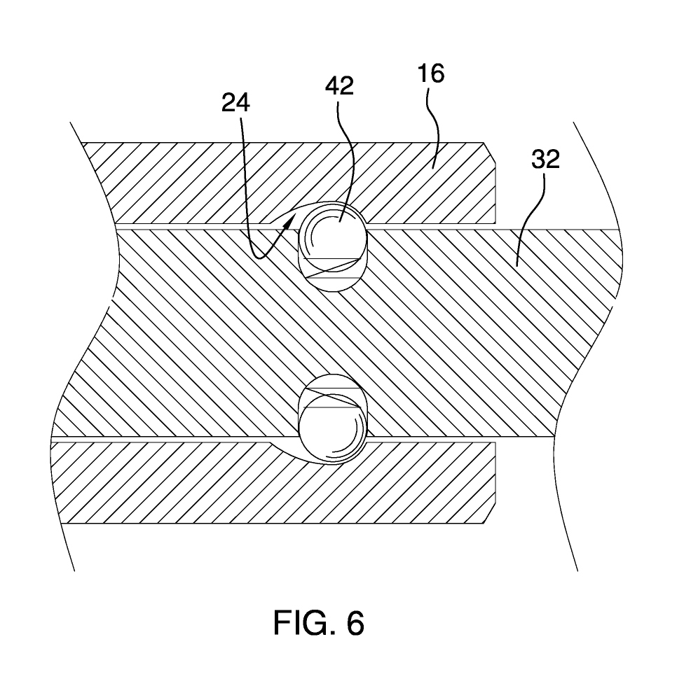

With reference now to the drawings, and in particular to FIGS. 1 through 6 thereof, a new power tool device embodying the principles and concepts of an embodiment of the disclosure and generally designated by the reference numeral 10 will be described.

As best illustrated in FIGS. 1 through 6, the dual sided drill bit system 10 generally comprises a power drill 12 that has a chuck 14. A receiver 16 is removably coupled to the chuck 14 and has an open end 18 that extends into a cavity 20 of the receiver 16. The cavity 20 has a bounding surface 22 that has a plurality of wells 24 therein. Each of the wells 24 is spaced from each other and is equidistant from the open end 18.

A bit 26 is included that has a first section 28, a second section 30 and a middle section 32 that is positioned between the first section 28 and the second section 30. The first, second and middle sections 28, 30, 32 form a unitary structure. The first section 28 has a first end 34 positioned opposite of the middle section 32 and the second section 30 has a second end 36 positioned opposite of the middle section 32. The first section 28 comprises a drill bit and the second section 30 comprises a screw driver. The screw driver may be any screw driver such as a Phillip's-head or a flat head, but should not be limited to such. The bit 26 is removably extended into the receiver such that a selected one of the first section 28 or second section 30 extends outwardly away from the receiver 16. The bit 26 is elongated between the first section 28 and the second section 30. The middle section 32 of the bit 26 has an outer surface 38 that comprises a plurality of planar surfaces 40 to facilitate engagement with the chuck 14.

A plurality of detents 42 is mounted on the bit 26. Each of the detents 42 removably extends into one of the wells 24 to releasably retain the bit 26 in the receiver 16. Each of the detents 42 is positioned in the middle section 32. The detents 42 may each comprise a ball or similar projection being biased outwardly from bit 42 by a biasing member such as a spring shown in FIG. 6.

In use, a drill bit or a screw driver is selected and a corresponding on of the first and second sections 28, 30 defines a selected tool. The bit 26 is removably positioned into the cavity 20 of the receiver 16 such that the selected tool extends outwardly from the receiver 16. The detents 42 releasably retain the bit 26 in the receiver 16 such that the bit 26 rotates when the power drill 12 is powered.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A reversible drill bit system configured to facilitate switching between a drilling tool and a screw driver tool, said system comprising;
a power drill having a chuck;
a receiver being removably coupled to said chuck, said receiver having an open end extending into a cavity of said receiver, said receiver having a closed end opposite said open end, said cavity having a bounding surface having a plurality of wells therein, each of said wells being spaced from each other and being equidistant from said open end; and
a bit having a first section and a second section and a middle section positioned between said first and second sections, said first, second and middle sections forming a unitary structure, said first section having a first end positioned opposite of said middle section and said second section having a second end positioned opposite of said middle section, said first section comprising a drill bit, said second section comprising a screw driver, said bit being removably extended into said receiver such that a selected one of said first or second sections extends outwardly away from said receiver, a plurality of detents being mounted on said bit, each of said detents being removably extended into one of said wells to releasably retain said bit in said receiver, each of said detents being centrally positioned on said middle section between said first section and said second section.

2. (canceled)

3. The reversible drill bit system according to claim 1, wherein
said bit is elongated between said first section and said second section.

4. The reversible drill bit system according to claim 1, wherein said middle section of said bit has an outer surface comprising a plurality of planar surfaces to facilitate engagement with said chuck.

5. (canceled)

6. The reversible drill bit system according to claim 1, wherein each of said detents is positioned in said middle section.

7. A reversible drill bit system configured to facilitate switching between a drilling tool and a screw driver tool, said system comprising;
a power drill having a chuck;
a receiver being removably coupled to said chuck, said receiver having an open end extending into a cavity of said receiver, said receiver having a closed end opposite said open end, said cavity having a bounding surface having a plurality of wells therein, each of said wells being spaced from each other and being equidistant from said open end;
a bit having a first section and a second section and a middle section positioned between said first and second sections, said first, second and middle sections forming a unitary structure, said first section having a first end positioned opposite of said middle section and said second section having a second end positioned opposite of said middle section, said first section comprising a drill bit, said second section comprising a screw driver, said bit being removably extended into said receiver such that a selected one of said first or second sections extends outwardly away from said receiver, said bit being elongated between said first section and said second section, said middle section of said bit having an outer surface comprising a plurality of planar surfaces to facilitate engagement with said chuck; and
a plurality of detents being mounted on said bit, each of said detents being removably extended into one of said wells to releasably retain said bit in said receiver, each of said detents being positioned in said middle section, each of said detents being centrally positioned on said middle section between said first section and said second section.
